(19) United States
(12) Patent Application Publication
(10) Pub. No.: US 2006/0206460 A1
(43) Pub. Date: Sep. 14, 2006

(54) Biasing search results

(76) Inventor: Sanjay Gadkari, Portland, OR (US)

Correspondence Address: INTEL CORPORATION, P.O. BOX 5326, SANTA CLARA, CA, 95056-5326, US

(21) Appl. No.: 11/080,114

(22) Filed: Mar. 14, 2005

(51) Int. Cl. G06F 17/30

(52) U.S. Cl. 707/3

(57) ABSTRACT

While various search engines may rank results based on general popularity or other characteristics of a search result, these search engines do not take into account one's personal web browsing history and past search history, including whether a searcher actually selected links in a previous search result, and to use this personal history to bias search results in favor of the searcher's history. Previously visited web pages and network resources accessed, e.g., by clicking on, for example, a link in a search result, are often a strong indicator of data of interest to a searcher. Search results related to such history can be given a higher relevance ranking in search results as such search results are likely to be of higher interest to a searcher.

### FIELD OF THE INVENTION

The invention generally relates to searching a network for data, and more particularly to biasing search results relevancy based at least in part on previous browsing activity and whether search results have been previously received or accessed.

### BACKGROUND

Since the advent of data networks, a frequent problem has been how to retrieve stored data. In particular, with the proliferation of massive storage capabilities, enormous data can be stored, and it becomes commensurately difficult to locate data of interest to a searcher. This is an especially acute problem when one considers the interconnection of various such networks, such as by way of the Internet.

In response to this difficulty, many different search engine companies have been formed to help one search for data. Well known search systems include those provided Yahoo.com, Google.com, etc. While these and many other search engines have various features and characteristics designed to assist one to search through enormous volumes of information, such as Google's ordering search results so that popular results are displayed first, Google and the other search engines nonetheless have deficiencies.

### BRIEF DESCRIPTION OF THE DRAWINGS

The features and advantages of the present invention will become apparent from the following detailed description of the present invention in which:

FIG. 1 illustrates a system of exemplary machines of which some or all of the illustrated items may be variously combined to provide biased search results in accordance with different embodiment possibilities.

FIG. 2 illustrates a flowchart according to one embodiment for performing a search with results biased in favor of a client's previous search history.

FIG. 3 illustrates a flowchart according to one embodiment illustrating tracking client browsing operations for biasing search results.

FIG. 4 illustrates a flowchart according to one embodiment of exemplary operations that may be performed in part to effect the FIG. 2 biasing.

FIG. 5 shows a spatial diagram illustrating the various search spaces that may be used to bias search results as discussed above with respect to FIGS. 1-4.

FIG. 6 illustrates a suitable computing environment in which certain aspects of the invention may be implemented.

### DETAILED DESCRIPTION

In particular, while Google and other search engines may rank results based on general popularity or other characteristics, these search engines do not take into account one's personal web browsing history and past search history, including whether a searcher actually selected links in a previous search result, to bias search results in favor of the searcher's history. Previously visited web pages and network resources accessed, e.g., by clicking on, for example, a link in a search result, are often a strong indicator of data of interest to a searcher. Consequently, search results related to such history should be given a higher relevance ranking in search results as they are likely to be of higher interest to a searcher.

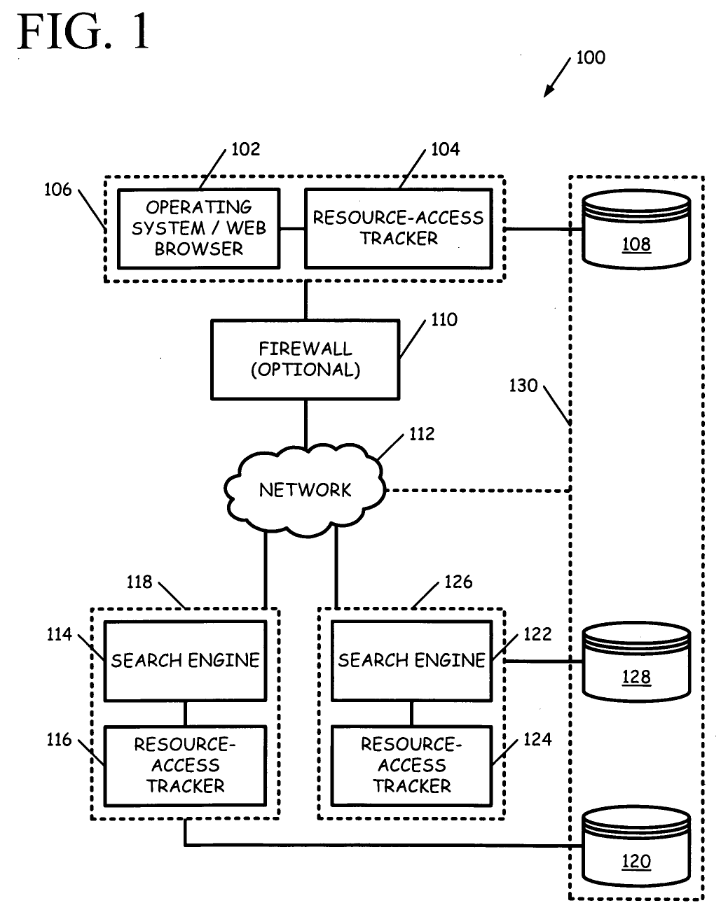

FIG. 1 illustrates a system 100 of exemplary machines of which some or all of the illustrated items may be variously combined to provide biased search results in accordance with different embodiment possibilities. It will be appreciated that different embodiments may use only some of the illustrated items, and other embodiments may use items or components not specifically illustrated. A client 102 is expected to issue search requests. In the illustrated embodiment, the client may be implemented as an operating system search component or web browser user or equivalent user interface to a search engine (e.g., items 114, 122 discussed below), but it will be appreciated the client may be implemented in many different ways, for example, as a dedicated search device, standalone device, disposed within another device such as a mobile device, in a low-level driver or operating system API (Application Programming Interface), etc.

In one embodiment, associated with the client 102 is a resource-access tracker 104. The tracker is intended to monitor the client's network resource access, including tracking web browsing, searching activities, etc. If we assume the client is web based, then the tracker may be implemented as a proxy through which the client's web communication is routed. It will be appreciated the proxy may be known (nontransparent) to the client, e.g., by setting the client's configuration to use the proxy for HTTP (HyperText Transport Protocol), HTTPS (Secure HTTP), or other protocols and communications as desired. Or, the proxy may be transparently installed such that the client is unaware of and/or unable to disable the proxy. Network monitors and traffic snooping devices are known and such technology may be used to implement the proxy/search monitoring. For example, the proxy may be transparently linked into the client's networking services, or network traffic from the client can be arranged to route through a device (or devices) for monitoring the client.

Illustrated also is a dashed box 106 to indicate that in various embodiment possibilities, the client 102 and the tracker 104 may be separate communicatively coupled devices, such as when an external device monitors the client's network traffic, or the client and tracker may be disposed within a single machine represented by the dashed box, such as when the tracker is installed within the operating system of the client or operates as at least a component of a browser or other software or hardware component of the client. The data that is tracked for resource access by the client may be recorded in a database 108 or other storage environment.

Also illustrated is an optional firewall 110 (or equivalent) that may be in use by the client to shield it from interference by other machines on a network 112, which typically is expected to be the Internet, but which may be some other network. Although not illustrated as such, it will be appreciated that the resource-access tracker may be integrated within the firewall since the firewall can be positioned as a single point through which all networking activity for the client (and other devices not illustrated of an internal network), and as such a central point it is well positioned to operate as the external device for monitoring the client's access activity.

As illustrated, communicatively coupled to the network 112 are search engines 114, 122. While only two are shown, it is understood that these simply represent two of the many possible search engines that may be contacted by the client 102 for searching for data of other machines (not illustrated) on the network 112. In the illustrated embodiment, the search engines may have their own resource-access trackers 116, 124 that may be in addition to, or in lieu of, the client's resource-access tracker 104. As with the client and as discussed above, the search engines and their trackers may be separate machines or devices, or the trackers may be integrated within the search engines. Also, as discussed above, the search engines will store client access data in a database 120, 128 or equivalent storage. However, while the client's tracker may be expected only to track the client's resource accesses, or the firewall 110 only for machines inside the firewall, the search engines typically will track accesses by many if not all clients that utilize its search or other services.

As will be appreciated, it may be viewed as inefficient for the client 102 and search engines 114, 122 to maintain different databases 108, 120, 128. In one embodiment, as indicated by the dashed lines, a single database 130 may instead be used in lieu of separate databases 108, 120, 128. It will be appreciated that the single database may be a logical database actually comprised of a distributed collection of storage devices. Alternatively, although not illustrated, it will be appreciated search engines 114, 122 may jointly access a common database, e.g., the combination of databases 120, 128 to allow multiple search engines to aggregate tracking of client resource accesses across the client's usage of different search engines. While not explicitly illustrated, it will be appreciated that various cryptological and privacy preservation rules and schemes known in the art may be employed to maintain the client's privacy while still facilitating the client's access to a common database across multiple search services.

It will be appreciated that various techniques may be employed to track the client's 102 network resource access history, e.g., web browsing history, searching history, etc., and, if desired, identity of a user of the client. In one embodiment in which search engines 114, 122 have associated trackers 116, 124, for each client, the search engines track an origin IP (Internet Protocol) address apparently originating a search request, assign a date/time stamp for the search, track links to resources identified in a search result determined in response to a search request, and optionally, store a copy of the resources themselves identified by the result links. It will be appreciated that data on the network 112 is largely ephemeral, with updates and replacements to content entirely out of the client's control. Since it cannot be guaranteed data will be available in future, in some embodiments, a copy of search results are archived in the database.

Thus, in various embodiments, browsing history including web pages accessed by the client, as well as certain resources identified a search result, e.g., by way of URL (Uniform Resource Locators) links or other demarcation, may be stored in one or more of the databases 108, 120, 128 depending on the particular embodiment configuration. Note that because the origin address for a search probably does not uniquely identify a client device, resource-access trackers 104, 116, 124 may associate a login name, machine name, NIC (Network Interface Card) MAC (Machine Access Code) address, GUID (Globally Unique IDentifier), or some other relatively unique moniker to track the client search history.

In one embodiment, all browsing history and resources identified in search results are stored in the database(s). In an alternate embodiment, to reduce storage requirements, various system-wide and personalized data retention policies and user/client preferences may be employed to control storage, automatic deletions and/or user alerts to perform data management. For example, one system-wide policy may be to only store web pages accessed by the client, and only store search result resources accessed by the client, e.g., by way of clicking on a URL in a search result.

By associating a date/time with searches, various embodiments may maintain not only a search history, but also a complete archived replica of all web pages accessed by a user of the client 102 by a search result or direct browsing, including historical versions of a specific web page at points in time when the user accessed it. It will be appreciated that local efficiencies may be realized if a particular resource is provided to multiple users of the client. Similarly, the search engines 114, 122 may also provide efficiencies by retaining only a single copy of accessed content. In one embodiment, the data stored in the databases 108, 120, 128 may be combined with that of an Internet archiving service such as the “Internet Archive Wayback Machine,” an archiving service allowing visitors to enter a URL (Universal Resource Locator), select a date range, and access an archived version of the Internet at that time. If the illustrated embodiment is combined with such an archiving service, it may be used dynamically to retrieve resources identified by links in search results, thus removing need to store the resources in the databases. Such an archiving service also makes all resources, ephemeral or not, available for later access.

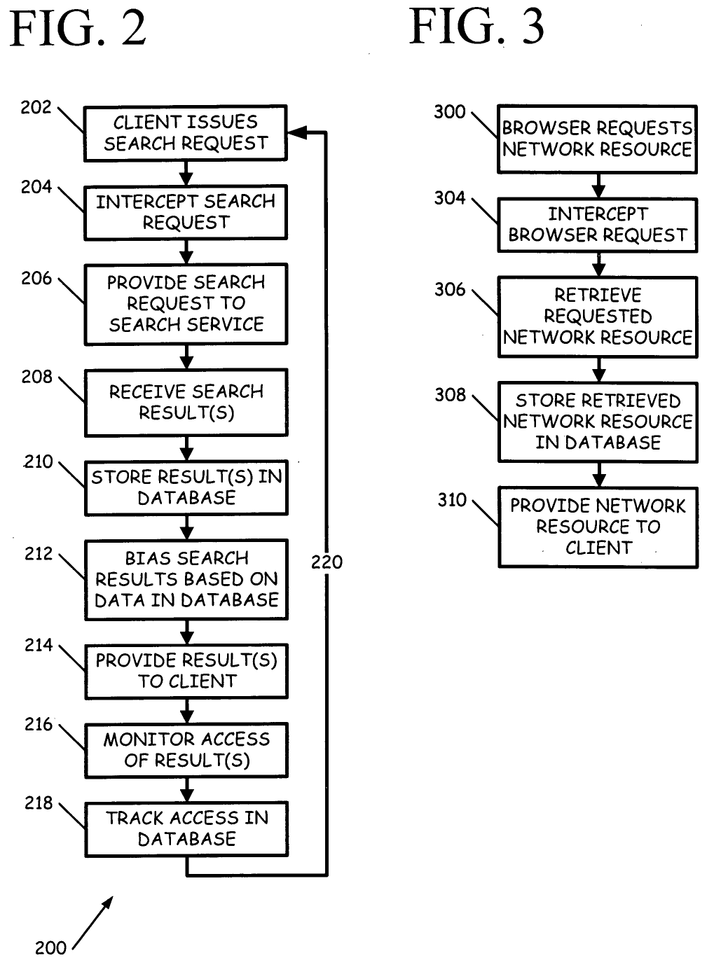

FIG. 2 illustrates a flowchart 200 according to one embodiment for performing a search with results biased in favor of a client's previous search history and, if we assume a web capable client, with respect to the client's browsing history.

A searching client, e.g., a user of a FIG. 1 item 102, issues a search 202 with a search engine. Not illustrated are potential search terms, restrictions, user preferences, e.g., language preferences, translation preferences, link validity testing, etc. that may be used to affect search results. As discussed above, a search request may be intercepted 204 by a proxy or other hardware and/or software intermediary able to receive or determine the search request and track the client's interaction and/or response to results from the search. For expository convenience, the term “proxy” will be used in the description and claims that follow to refer generally to known or unknown intermediary possibilities discussed above.

The intercepted 204 search request is provided 206 to the desired search service, such as selected ones of FIG. 1 search engine items 114, 122. Responsive to the search request, a search result is received 208 is received either directly by the client or indirectly by way of a known proxy; the search result may be a web page or other data containing URLs or other demarcations indicating web pages or other network accessible resources determined to have relevance to the search request. The proxy monitors the search result and stores 210 selected ones or all of the search results in a database. It will be appreciated that certain results might not be stored, such as excessively common results, or results contrary to a policy of a user of the client 102. Based on the previously stored results in the database, e.g., based on the client's previous search history, the received 208 results are biased 212 based on the client's previous search history, browsing history etc.

As will be appreciated, if there are many search results, a user of the client typically is only willing to access a few of the results and will not wade through many results to see if desired results are present in the results. It will be appreciated it is therefore important to make results likely to be important or relevant to a user of the client to appear at or near the top of the search result to increase the likelihood that the result will be reviewed by the user of the client. Note that the term “access” is context sensitive in the sense that its meaning depends on the nature of the search results. If we assume the results are links to web resources identified in a web page, then accessing generally refers to clicking on a link in the search result web page. Other results may require other forms of accessing.

Once the results have been biased 212 in favor of the client history, the biased results are provided to the client. In the illustrated embodiment, the proxy monitors 216 whether the client actually accesses any search result. Typically, many search results are facially determined (e.g., by way of looking at provided context) not to be what the user of the client is seeking. Ones that are accessed are typically of interest to the user of the client so this becomes valuable (more relevant) search history information that is tracked 218 within a database. Once the search results and accesses thereof (if any) are tracked in the database, the illustrated process may continue 220 with a subsequent search that then becomes biased with respect to the most recent search along with previous search results.

The above FIG. 2 discussion makes reference to biasing search results based at least in part on browsing history. FIG. 3 is a flowchart according to one embodiment illustrating tracking client browsing operations for biasing search results. That is, in addition to the FIG. 2 discussion of assigning higher relevance to search results previously accessed, search results that correspond to previously visited network resources, such as a web page, may also be considered to have a higher relevancy in search results identifying the previously visited network resources,

It should be appreciated that even though the illustrated operations are presented in a different figure than for the FIG. 2 operations, the two flowcharts of FIGS. 2 and 3 may be practiced contemporaneously and/or asynchronously, such as in parallel execution threads or parallel processing contexts. As illustrated, similar to intercepting 204 client search requests, when a browser attempts to browse 302 a network resource, that attempt is intercepted 304. As discussed above, a proxy, which may be one or more of resource-access trackers, e.g., FIG. 1 items 104, 116, 124, network devices, e.g., firewall item 110, etc., may perform the intercepting 304.

In the illustrated embodiment, the proxy retrieves 306 the requested network resource, e.g., a web page or other network accessible resource, and stores 308 the retrieved resource in the database. It is assumed for expository convenience that the database is the same one as used to store 210 search results in FIG. 2. Also, while the illustrated embodiment speaks of the proxy retrieving 306 the requested network resource, this may simply entail the proxy acting as a conduit for data that is in fact retrieved by another device (not illustrated) external to the proxy, e.g., a second-level proxy for the proxy. The retrieved network resource may then be provided 310 to the client browser as requested. Thus, the database may accumulate stored 210, 308 copies of network resources accessed by a client, along with search results accessed by the client, and this information used to bias future searching performed by the client.

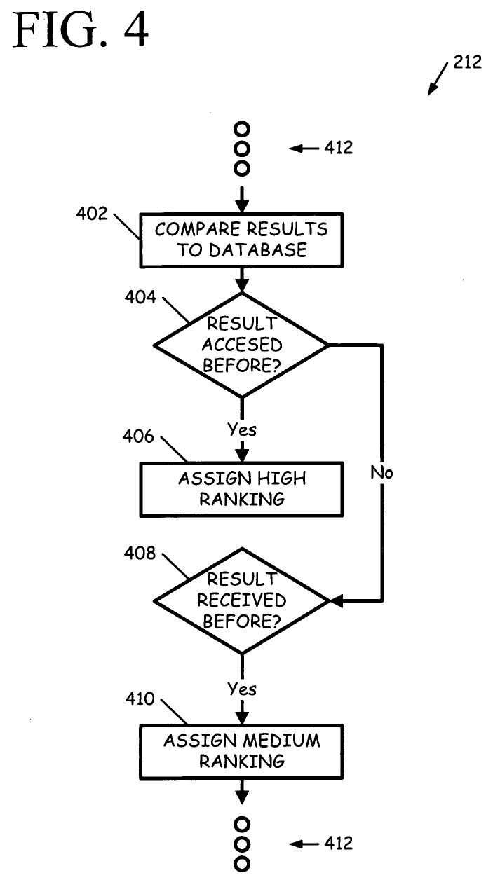

FIG. 4 illustrates a flowchart of exemplary operations that may be performed in part to effect the FIG. 2 biasing 212. It will be appreciated by one skilled in the art there can be many different techniques for performing the biasing. As illustrated, biasing may include comparing 402 a received search result with a database, where the database may store data including a client's (or user thereof) search history and/or browsing history as discussed above with respect to FIG. 2 and FIG. 3. Ellipses 412 are intended to represent that illustrated operations 402-410 are exemplary and other actions in lieu of or in addition to those illustrated may be performed when biasing.

A test may be performed to determine if 404 the result (or results) have been accessed previously, e.g., if the client is a web browser and a search result a web page containing links/URLs to other network accessible resources, was a link in a search result previously clicked on by a client user? Recall the proxy may monitor web browsing and monitor receiving search results from search engine(s), relative rankings may be used by the client to rearrange search results in accord with a determined relevancy based at least in part on relevancy of the search result to the client's search and browsing history. If the result was previously accessed by the client, the result is deemed relatively important and is assigned 406 a high ranking relative to other search results that may have been received.

If 404 the result was not previously accessed by the client, then in the illustrated embodiment, a further test may be performed to determine if 408 the result or portion thereof has been received before. For example, if the result is a web page having links (e.g., URLs) to network accessible resources, then URLs may be checked to see if they refer to network resources that have been accessed (e.g., browsed to) before. If so, these links can be assigned 410 a medium relative ranking to indicate their heightened relevance in the search results.

In the illustrated embodiments, when a search is performed, received search results that correspond to previously accessed search results are considered to have a “high” relevancy. Similarly, search results that correspond to previously accessed network resources, such as a web page, or web page object, these search results are considered to have a “medium” relevancy. It will be appreciated by one skilled in the art that the “high” and “medium” distinctions are arbitrary, and, for example, previously accessed network resources may be considered equally as important or more important than previously accessed search results. In another embodiment, not illustrated, there are only two classes of search results, new search results not seen before, and previously accessed network resources, e.g., medium ranked web pages previously browsed to by the client, with no preference given to previously accessed search results.

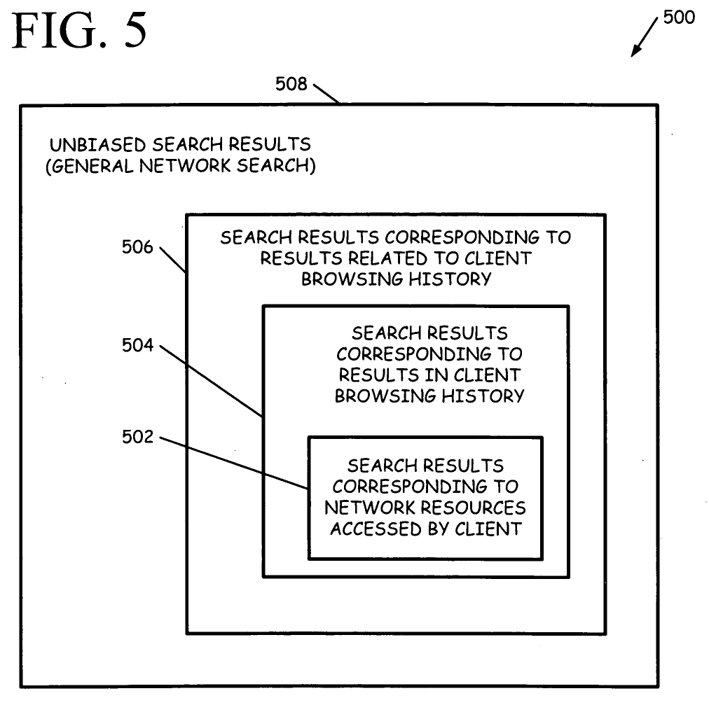

FIG. 5 shows a spatial diagram 500 illustrating the various search spaces that may be used to bias search results as discussed above with respect to FIGS. 1-4. The inner-most rectangle 502 corresponds to search results that have been tracked as having been accessed by the client. As discussed in FIG. 4, such previously accessed search results are assigned a high relevancy rating. The next outer rectangle 504 corresponds to the client's browsing history, e.g. network resources such as web pages that were previously accessed by the client. As discussed in FIG. 4, such previously accessed network resources are assigned a medium relevancy rating. The next outer rectangle 506 corresponds to web pages within the client's tracked browsing history that are related to the client's search results. That is, search engines such as Google.com, and other search engines provide an ability to locate “related pages” for a particular web page identified in a search result.

Various techniques may be employed to determine related pages, such as performing semantic and/or syntactic analysis to assign one or more taxonomy classifications to a particular web page, and then using the classifications to cross-link different potentially-related pages. Or, a mapping of forward and backward links, e.g., URLs or the like, may be traversed to determine whether two pages are somehow related through some number of link traversals, where, for example, a shorter route indicates a stronger cross-reference. When the client issues a search request, rectangle 506 corresponds to previously accessed network resources, such as web pages, that are determined to be related to a current search query. In effect, results are biased towards things a user of the client has already seen/accessed.

The outer-most rectangle 508 corresponds to the rest of the network, e.g., the rest of the Web/Internet that could be identified in a search result but are unrelated to the client's previous searching or browsing activity tracked by resource-access trackers, e.g., FIG. 1 items 104, 116, 124. In one embodiment, the net effect of these search spaces is to bias 212 search results as discussed in FIG. 2 so that previously accessed network resources from a previous search results (item 502) are displayed at or near the top of a current search result, followed by network resources previously browsed to by the client (item 504), followed by network resources related to the search results (item 506), then by general results (item 508). In one embodiment, search results corresponding to various search spaces are visually distinguished, such as by a different color, icon, sound, etc., and/or presented in a different output box or window.

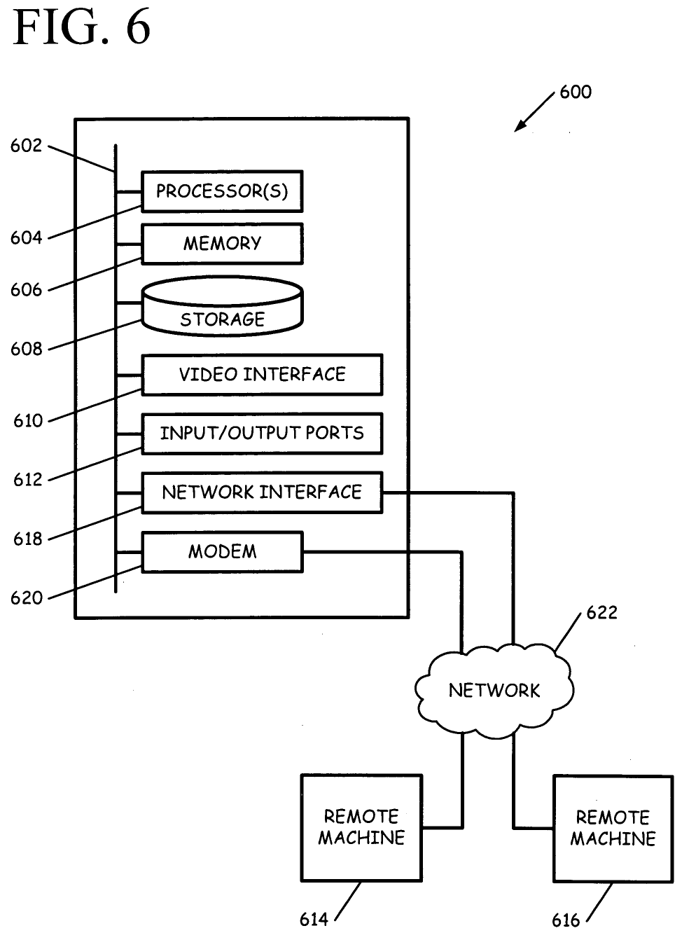

FIG. 6 and the following discussion are intended to provide a brief, general description of a suitable environment in which certain aspects of the illustrated invention may be implemented. As used herein below, the term “machine” is intended to broadly encompass a single machine, or a system of communicatively coupled machines or devices operating together. Exemplary machines include computing devices such as personal computers, workstations, servers, portable computers, handheld devices, e.g., Personal Digital Assistant (PDA), telephone, tablets, etc., as well as transportation devices, such as private or public transportation, e.g., automobiles, trains, cabs, etc.

Typically, the environment includes a machine 600 that includes a system bus 602 to which is attached processors 604, a memory 606, e.g., random access memory (RAM), read-only memory (ROM), or other state preserving medium, storage devices 608, a video interface 610, and input/output interface ports 612. The machine may be controlled, at least in part, by input from conventional input devices, such as keyboards, mice, etc., as well as by directives received from another machine, interaction with a virtual reality (VR) environment, biometric feedback, or other input source or signal.

The machine may include embedded controllers, such as programmable or non-programmable logic devices or arrays, Application Specific Integrated Circuits, embedded computers, smart cards, and the like. The machine may utilize one or more connections to one or more remote machines 614, 616, such as through a network interface 618, modem 620, or other communicative coupling. Machines may be interconnected by way of a physical and/or logical network 622, such as the network 112 of FIG. 1, an intranet, the Internet, local area networks, and wide area networks. One skilled in the art will appreciated that communication with network 622 may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data such as functions, procedures, data structures, application programs, etc. which when accessed by a machine results in the machine performing tasks or defining abstract data types or low-level hardware contexts. Associated data may be stored in, for example, volatile and/or non-volatile memory 606, or in storage devices 608 and their associated storage media, including hard-drives, floppy-disks, optical storage, tapes, flash memory, memory sticks, digital video disks, biological memory devices, e.g., machine-accessible biology-based state preserving mediums, etc. Associated data may be delivered over transmission environments, including network 622, in the form of packets, serial data, parallel data, propagated signals, etc., and may be used in a compressed or encrypted format. Associated data may be used in a distributed environment, and stored locally and/or remotely for access by single or multiprocessor machines. Associated data may be used by or in conjunction with embedded controllers; hence in the claims that follow, the term “logic” is intended to refer generally to possible combinations of associated data and/or embedded controllers.

Thus, for example, with respect to the illustrated embodiments, assuming machine 600 embodies the client 102 of FIG. 1, then remote machines 614, 616 may respectively be FIG. 1 search engines 114, 122. It will be appreciated that remote machines 614, 616 may be configured like machine 600, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for searching a network, comprising:
providing an archive storing one or more of
search results for search requests issued by at least a first machine and
network resource accesses by at least the first machine, the archive determined at least in part by previously performing one or more of
intercepting a first search request of the first machine,
providing the first search request to a first search service,
receiving first search results from the search service,
monitoring an access of network resources by the first machine, and
associating with the first machine in the archive selected ones of the first search results and said monitored access of network resources;
intercepting a second search request;
providing the second search request to a second search service; and
determining second search results having a first relevancy order based at least in part on a biasing of said second search results in favor of said associated first search results and said monitored access of network resources.

2. The method of claim 1, further comprising:
providing a web browser of the first machine operable to perform the access of network resources.

3. The method of claim 1, said associating in the archive selected ones of the first search results with the first machine further comprising tracking access of the selected ones of the first search results.

4. The method of claim 2, said determining the archive further comprising storing in the archive at least portions of network accessible data corresponding to said accessed first search results.

5. The method of claim 2, said biasing the second search results comprises assigning a higher relevancy to search results corresponding to previously accessed ones of said first search results.

6. The method of claim 2, said biasing the second search results comprises:
identifying selected second search results contextually related to results of said first search results lacking indication in the archive as being accessed; and
assigning a lower relevancy to said contextually related second search results.

7. The method of claim 1, wherein the first and second search results comprise links to network accessible data, and wherein determining the archive further comprises storing in the archive at least portions of network accessible data corresponding to said selected ones of the first search results.

8. The method of claim 1, said determining the archive further comprising providing a web page to the first machine containing the first search results.

9. The method of claim 1, wherein the first and second search service are the same search service.

10. The method of claim 1, further comprising applying restrictive-criteria to adjust the bias of said relevancy order for the second search results.

11. The method of claim 1, wherein the second search service returns ordered search results having a relevancy order based at least in part on a popularity rating determined for selected ones of returned search results.

12. The method of claim 1, wherein the method is performed in a selected one of: the same machine, or a second machine different from the first machine.

13. A networking system comprising:
first logic for a network application program operable to issue a search query and selectively access network resources identified in a search result responsive thereto;
second logic for a resource-access tracker operable to archive selected ones of accesses by the network application program of said network resources; and
third logic for a bias mechanism operable to generate a biased search result biasing the search result with respect to said archive of selected network accesses.

14. The system of claim 13, further comprising logic for an operating system, wherein said logic for the operating system includes said first logic.

15. A method for searching a network, comprising:
receiving a first search request from a first source;
determining a first search result corresponding to the first search request and at least identifying one or more links to network accessible resources, of which selected ones of said first search result links to be associated in an archive with the first source;
receiving a second search request from the first source;
determining a second search result corresponding to the second search result and at least identifying one or more links to network accessible resources; and
biasing a relevancy ordering of links in the second search result based at least in part on archived links of the first search result.

16. The method of claim 15, further comprising:
performing said determining the first search result by a first machine; and
archiving said selected ones of said first search result links by a second machine different from the first machine.

17. The method of claim 15, wherein biasing the ordering of links comprises giving a higher relevancy to links of said first search results determined to have been accessed by the first source.

18. The method of claim 15, further comprising:
receiving a third search request from a second source;
determining a third search result corresponding to the third search request and at least identifying one or more links to network accessible resources, the third search result having a relevancy ordering based at least in part on whether said links of said third search result have been accessed by the first source;
wherein selected ones of said first third result links are to be associated, in the archive, with the second source.

19. The method of claim 18, further comprising:
receiving a fourth search request from the second source;
determining a fourth search result corresponding to the fourth search result and at least identifying one or more links to network accessible resources; and
biasing a relevancy ordering of links in the fourth search result based at least in part on archived links of the third search result.

20. The method of claim 19, wherein biasing the ordering of links of the fourth search result comprises giving a higher relevancy to links of said third search results determined to have been accessed by the second source.

21. An article comprising a machine-accessible media having associated data for searching a network, wherein the data, when accessed, results in a machine performing:
accessing an archive storing one or more of search results for search requests issued by at least a first machine and network resource accesses by at least the first machine, the archive determined based at least in part by previously performing one or more of
intercepting a first search request of the first machine,
providing the first search request to a first search service,
receiving first search results from the search service, and
associating in the archive selected ones of the first search results with the first machine;
intercepting a second search request;
providing the second search request to a second search service; and
determining second search results having a first relevancy order based at least in part on a biasing of said second search results in favor of the selected ones of the first search results.

22. The article of claim 21 wherein the machine-accessible data for said biasing the second search results further includes data, which when accessed, results in the machine performing:
assigning a higher relevancy to search results corresponding to previously accessed ones of said first search results.

23. The article of claim 22 wherein the machine-accessible data for said biasing the second search results further includes data, which when accessed, results in the machine performing:
identifying selected second search results contextually related to results of said first search results but lacking indication in the archive as being accessed, and assigning a lower relevancy thereto.

24. An article comprising a machine-accessible media having associated data for searching a network, wherein the data, when accessed, results in a machine performing:
receiving a first search request from a first source;
determining a first search result corresponding to the first search request and at least identifying one or more links to network accessible resources, of which selected ones of said first search result links to be associated in an archive with the first source;
receiving a second search request from the first source;
determining a second search result corresponding to the second search result and at least identifying one or more links to network accessible resources; and
biasing a relevancy ordering of links in the second search result based at least in part on archived links of the first search result.

25. The article of claim 24 wherein the machine-accessible data for biasing the ordering of links further includes data, which when accessed, results in the machine performing:
assigning a higher relevancy to links of said first search results determined to have been accessed by the first source.

26. The article of claim 25 wherein the machine-accessible data further includes data, which when accessed, results in the machine performing:
receiving a third search request from a second source;
determining a third search result corresponding to the third search request and at least identifying one or more links to network accessible resources, the third search result having a relevancy ordering based at least in part on whether said links of said third search result have been accessed by the first source;
receiving a fourth search request from the second source;
determining a fourth search result corresponding to the fourth search result and at least identifying one or more links to network accessible resources; and
biasing a relevancy ordering of links in the fourth search result based at least in part on determining whether said third search results have been accessed by the second source.
